(19) United States
(12) Patent Application Publication
(10) Pub. No.: US 2007/0041758 A1
(43) Pub. Date: Feb. 22, 2007

(54) Multiple pressure roll fuser

(75) Inventors: Anthony S. Condello, Webster, NY (US); Donald M. Bott, Rochester, NY (US); Jeremy C. De Jong, Webster, NY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: XEROX CORPORATION

(21) Appl. No.: 11/205,483

(22) Filed: Aug. 17, 2005

(51) Int. Cl. G03G 15/20

(52) U.S. Cl. 399/328

(57) ABSTRACT

A fuser system of a xerographic device provides a fuser roll, and first and second pressure rolls supported for selective engagement with the fuser roll. The fuser system further provides a repositioner which cooperates with the first and second pressure rolls for operatively selectively engaging one of the first and second pressure rolls with the fuser roll. The first pressure roll can include an outer surface having an effective modulus creating a first nip pressure, and the second pressure roll can include an outer surface having an effective modulus creating a second nip pressure. The selection of the first or second pressure roll can be in response to the media paper weight and/or image content being processed through the xerographic device.

### BACKGROUND

This disclosure relates to a fuser system that includes multiple singly-loaded pressure rolls that can be individually and selectively ‘cammed in’ or loaded depending on the media, as well as image type (text vs. full pictorial), being fed through the fuser. Each roll can produce a specific combination of dwell/stripping creep which is suitable for a given media (paper weight) range.

In the art of xerography or other similar image reproducing arts, a latent electrostatic image is formed on a charge-retentive surface, i.e., a photoconductor or photoreceptor. To form an image on the charge-retentive surface, the surface is first provided with a uniform charge after which it is exposed to a light or other appropriate image of an original document to be reproduced. The latent electrostatic image thus formed is subsequently rendered visible by applying any one of numerous toners specifically designed for this purpose.

It should be understood that for the purposes of the present disclosure, the latent electrostatic image may be formed by means other than by the exposure of an electrostatically charged photosensitive member to a light image of an original document. For example, the latent electrostatic image may be generated from information electronically stored or generated, and this information in digital form may be converted to alphanumeric images by image generation electronics and optics. The particular method by which the image is formed is not critical to the present disclosure, and any such suitable method may be used.

In a typical xerographic device, the toner image formed is transferred to an image receiving substrate such as paper. After transfer to the image receiving substrate, the image is made to adhere to the substrate using a fuser apparatus. To date, the use of simultaneous heat and contact pressure for fusing toner images has been the most widely accepted commercially, the most common being systems that utilize a pair of pressure engaged rolls.

The use of pressure engaged rolls for fixing toner images is well known in the art. See, for example, U.S. Pat. Nos. 6,289,587, 5,998,761, 4,042,804 and 3,934,113.

At the time of initial set-up of a xerographic device, the fuser system is set to be within certain specifications. Some of these specifications include nip, load, and speed. Other parameters of the fuser system include dwell time, pressure, and creep. Dwell time (nip width/process speed) is one of the more significant drivers of image fix and quality. Paper velocity is also an important factor in paper handling. Relative paper velocity along the length of the nip is important to paper handling, while absolute velocity is of less importance. Changes in velocity can be made in response to low area coverage (text) on light weight media by using a softer pressure roll than used for high area (full pictorial) images on the same substrate. Creep, which is the release surface's % extension in the nip, is important with respect to enabling self-stripping of the paper from the fuser roll. These specifications are set by, for example, setting a roll rotation speed for the paper velocity and setting the nip width for the dwell time and creep.

Once initially set, the nip width of a typical fuser is not changed during operation of the xerographic device. Unfortunately, several internal and external factors can cause the fuser system to drift outside of the designated specifications. For example, in a typical soft-on-hard roll pair in which the soft roll is the driving roll, the fuser system may begin operating outside of specifications due to, e.g., hardening of the roll materials over time. Typical fuser roll systems include some materials such as silicone materials that tend to become harder or softer over time at unpredictable rates. This hardening causes large reductions in both dwell time and creep, which causes premature failure (e.g., smaller nip widths that lead to insufficient fixing of the toner image and/or poor image quality, as well as to poor stripping of the image receiving substrate).

In addition to these failure modes, it is at times desired that the nip width in a fuser be altered on demand. For instance, the fusing quality on thick paper is improved with large nip widths, and the fusing quality on thin papers is often improved with small nip widths. The fusing latitude in the presence of varied media and images, therefore, is improved if the nip width can be accurately set and controlled.

Typically, resetting the nip width to improve fusing latitude or to compensate for system failures due to the fuser system falling out of specifications has been dealt with by either (a) having a technician re-set the nip on site and/or (b) setting the nip width far above specifications at the factory, permitting the device to operate longer before falling out of specification. However, each of these ‘solutions’ has serious problems. Using technicians to reset the nip requires an on site visit by a technician and down time of the device. Initially setting the nip width high above specifications can cause paper handling and stripping issues, especially with lightweight papers.

Optimal fusing of toner images requires the correct combination of fuser temperature, pressure, and time (dwell) in the nip which is heavily influenced by the media properties (weight, roughness, coating, thermal conductivity, etc.). The ideal fusing system would have the ability to instantaneously adjust these parameters to match media and image characteristics while maintaining xerographic process speeds. The current method to accommodate fusing of a wide range of media is to change the speed of the paper path (loss in productivity) and/or change the temperature (life reduction and time consuming) of the fuser. Any decrease in productivity or idle time spent waiting is considered a huge detriment and to be avoided.

A fuser system, in particular its pressure roll, optimized for heavy papers is very different than one optimized for thin papers. Heavy weight papers require longer dwells, but also require lower image-side creep due to their increased beam strength. Light papers do not require long dwells, but do require high image-side creep. Therefore, a fuser optimized for thin papers would have a relatively hard pressure roll, producing high fuser roll creep but small dwells, while a fuser optimized for thick papers would have a relatively soft pressure roll, producing long dwells but low fuser roll creep. Current fusers cannot produce the nip conditions to simultaneously support both thin and thick papers at speeds beyond 100 ppm. The mainline platform approach is to change fuser roll operating temperature, reduce process speed, or have separate fusers for thin and thick paper that can be inserted into the machine for either thin or thick print jobs.

### SUMMARY

The present disclosure provides a fuser system of a xerographic device comprising a fuser roll, a first pressure roll, and a second pressure roll supported for selective pressure engagement with said fuser roll. The fuser system further provides for a repositioner cooperating with the first and second pressure rolls for operatively selectively engaging one of the first and second pressure rolls with the fuser roll.

The present disclosure also provides a xerographic method including operating a heat and pressure fuser having a heated fuser roll, and a plurality of pressure rolls each selectively supported for pressure loading against the fuser roll. The method further provides for selectively moving a first one of the plurality of pressure rolls to a loaded position with the fuser roll in response to a sensor detecting a first weight of media passing through the xerographic device.

The present disclosure also provides a fuser system of a xerographic device comprising a fuser roll, at least a first and a second pressure roll supported by a repositioner. The repositioner cooperates with the at least first and second pressure rolls for operatively selectively loading one of the at least first and the second pressure rolls with the fuser roll.

### BRIEF DESCRIPTION OF THE DRAWINGS

FIG. 1 illustrates a mounting structure for a fuser roll and a plurality of pressure rolls for a xerographic device; and,

FIG. 2 illustrates the relationship between the fuser roll surface creep and pressure roll rubber thickness with respect to dwell time.

### DETAILED DESCRIPTION

A typical xerographic machine includes at least a toner image forming station, a transfer station to transfer the toner image to an image receiving substrate, and a fuser system to fix the toner image to the image receiving substrate. At the toner image forming station, a latent image of an original image is developed, typically on the surface of a photoconductor or photoreceptor, using a suitable toner material. The developed toner image is then transferred to an image receiving substrate such as paper, transparencies, stock, media, etc., at a transfer station. Following transfer to the image receiving substrate, the toner image must then be fixed to the image receiving substrate, which is done by a fuser system that applies heat and pressure to the substrate having the toner image thereon.

It is desirable to have the ability to selectively modify the dwell time (nip width at constant speed) for a given fuser and set temperature in order to enable the rapid optimization of fix and gloss for a given toner image on a given substrate. It is well understood in color fusing systems that thick papers require more and thin papers less dwell time (at the same pressure & temperature) to achieve adequate image permanence and gloss. It is also known that light weight media require greater nip creep and higher creep rate upon nip exit than do thicker substrates in order to promote self stripping.

In the absence of a pressure roll whose hardness can be tuned for thin vs. thick paper, a similar effect can be accomplished by using a plurality of pressure rolls, and engaging or loading them independently based on the media being fed. Selecting and engaging one of the pressure rolls, from the plurality, is based upon the paper/image content of the incoming media. This provides for quick changing of the pressure roll in order to accommodate maximum productivity for an entire range of media without the need to cool down and manually replace the pressure roll. Manually changing a pressure roll can take upwards of approximately 30 minutes.

The system and method described hereinafter provides for rapid changeover from one pressure roll to another without manual intervention and the corresponding machine downtime. A fuser system 10 of the present disclosure can include an assembly comprising a plurality, for example 2-4, of pressure rolls 12, 14, 16 that are each individually ‘cammed in’ or loaded depending upon the media being fed. Each roll 12, 14, 16 produces a specific combination of dwell/stripping creep which can be optimized for a given media range and/or image content. The roll that is best suited for the particular incoming media can be loaded against a fuser roll 20, while the unused rolls are idling (unloaded).

The fuser roll 20 can be comprised of, for example, a fuser belt traveling around one or more (fuser) rolls. The term “fuser roll” as used herein collectively refers to any configuration of a fuser used to contact the toner image in fixing the toner image to the image receiving substrate. Similarly, the fuser system of the present disclosure is comprised of a pressure member that may be comprised of, for example, a pressure roll, or a pressure belt traveling around one or more rolls. The term “pressure member” as used herein collectively refers to any member loaded against the fuser member and used to apply pressure to the image and media substrate 24 passed between the fuser member and pressure member.

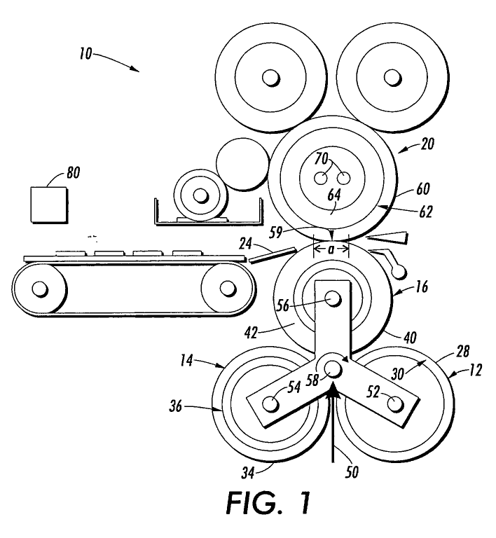

It is to be appreciated that the fuser system 10 can comprise one fuser roll 20 and at least a pair of pressure rolls (i.e. pressure rolls 12, 14, 16). By way of illustration only, one arrangement of pressure rolls of the present disclosure is illustrated in FIG. 1. Pressure roll 12 can include a Teflon® layer 28 over an aluminum layer 30 which is suitable for light weight or thin paper (i.e. approximately 67-90 grams/square meter [gsm]). At high speeds this configuration would create a small nip, short dwell and high fuser roll creep. Pressure roll 14 can include a Teflon layer 34 over a silicone layer 36 which is suitable for medium weight paper (i.e. approximately 90-140 gsm). In one embodiment, pressure roll 14 can include a silicone layer 36 approximately 4-5 mm thick having an effective modulus of approximately 2.5 MPa which provides a nip suitable to support fixing of medium weight paper. This configuration can produce a moderate dwell, moderate creep that can be used to fuse the medium weight paper where stripping is less of a concern and longer dwells are desired. Pressure roll 16 can include a Teflon layer 40 over a silicone layer 42 which is suitable for heavy weight or thick paper (i.e. approximately 140-270 gsm). Pressure roll 16 can be a relatively soft pressure roll which can generate a very large fusing nip (i.e. 21.8 mm or 31 ms at 150 ppm) which is needed for adequate fixing of current heavy weight paper. In one embodiment, pressure roll 16 comprises a silicone layer 42 approximately 7-9 mm thick having an effective modulus of approximately 1.5 MPa which provides a large fusing nip for adequate fixing of heavy weight paper. The beam strength of the thick paper is stronger than the tacking forces of the toner to the roll surface and the paper will exit normally.

As described above, the fuser system may include two or more pressure rolls. Each pressure roll 12, 14, 16 can have a predeterminable hardness which is selected to handle a range of paper weight. Engaging the relatively hard pressure roll 12 enables good stripping of thin papers and reduces the tendency to over fuse, while engaging the relatively soft pressure roll 16 creates a very long dwell and ensures permanence on heavy paper stock. The soft pressure roll 16 would also greatly reduce the fuser roll creep and self-stripping capability, but heavy papers need little stripping assistance.

As shown in FIG. 1, the movement of the pressure rolls is by way of a ‘carousel’ or repositioner 50. It is to be appreciated that any number of different pressure rolls can be mounted to the repositioner 50, or a combination of repositioners could be employed (not illustrated). The repositioner 50 includes three axles 52, 54, 56 upon which pressure rolls 12, 14, 16 are mounted, respectively. A central axis 58 provides for rotation of the repositioner 50 and loading of the desired pressure roll 12, 14, or 16. As shown in FIG. 1, the productivity output can be approximately 150 pages per minute (ppm) using a 4-inch diameter roll pair and color fusing while enabling a wide media range with constant load and limited transition time.

As illustrated in FIG. 1, pressure roll 16 is brought to exert pressure upon fuser roll 20, thereby forming a nip 59 having a nip width “a” between the pressure roll 16 and fuser roll 20. The image receiving substrate 24 having a toner image thereon is made to pass through the nip 59 such that the toner image contacts the fuser roll surface. The toner image is fixed to the image receiving substrate 24 via heat and pressure. As the image receiving substrate exits from the fuser system 10, the image receiving substrate is stripped from the fuser roll 20. Preferably, the stripping is a self-stripping, although stripping fingers or other stripping devices may also be used to assist in the stripping as is well known in the art.

The fuser roll 20 of the present disclosure may have any construction and design, without limitation. However, the disclosure as it relates to maintaining velocity over life is most applicable to fuser rolls having one or more layers thereof comprised of a material that has a tendency to harden over time. For example, such materials may include silicone materials, and thus the disclosure is applicable to fuser members comprised of one or more layers of a silicone material.

In one embodiment of the disclosure, the fuser roll includes at least one layer including a silicone material. The fuser roll 20 can include an outer layer 60 and an optional intermediate layer 62 upon suitable base member 64 which may be either a solid or hollow cylinder or core fabricated from any suitable metal such as aluminum, anodized aluminum, steel, nickel, copper, and the like. Hollow cylinders or cores are preferred as such can be heated from inside the cylinder or core. For example, a suitable heating element 70 may be disposed in the hollow portion of the cylinder or core. Alternatively, any suitable external heating option may also be used. It is to be appreciated that pressure rolls 12, 14 cooperate with fuser roll 20 to form other nip widths (not illustrated).

Additionally, internal or external factors may require the nip width of the operating fuser to be adjusted to a new specification range. For example, the fusing of thick paper might change the operational specification range.

In the present disclosure, paper weight and/or a property from which the nip width can be derived is monitored. The relationship between a monitoring sensor 80, the pressure rolls 12, 14, 16, the fuser roll 20, and the repositioner device 50 is shown in FIG. 1. The monitoring device 80 provides the measured values for the paper weight while the digital front end communicates the image content to a processor (not illustrated), which then compares the measured/determined current nip characteristics (width & creep) of the fuser member to the desired specification. If the current nip width is determined to be out of an acceptable specification range, the processor then signals the repositioner device 50 to appropriately move the desired pressure roll into the engaged position with the fuser roll 20, thereby changing the nip width to bring the nip width back into the desired specification range.

Although the monitoring device 80 may be a sensor for any of numerous values within the fuser system 10, for example for directly monitoring nip width or indirectly monitoring indicators of nip width such as paper speed exiting from the fuser system, paper buckle prior to entering the fuser system, fuser roll to pressure roll center-to-center distribution, etc., it is provided in the present disclosure for the sensor 80 to measure paper weight within the system from which nip width can be derived.

The monitoring sensor 80 is in communication with the processor so that the data measured by the sensor may be sent to the processor. Although wireless communication is possible, it is typically suitable to use conventional cabling between the sensor 80 and the processor in order for the processor to be able to reliably receive the data from the monitoring sensor 80.

The processor evaluates the received data to determine a value for the measured, or current, nip width of the fuser system. Where the received data is the paper weight in grams per square meter (gsm), the data is converted to a nip width value by the processor. This can be done by any suitable means, for example through use of a lookup table stored in the processor. Such a lookup table can store the nip widths corresponding to various paper weights. The processor may also calculate the current nip width value from the paper weight, and/or image content, data using an appropriate function equation stored in the processor.

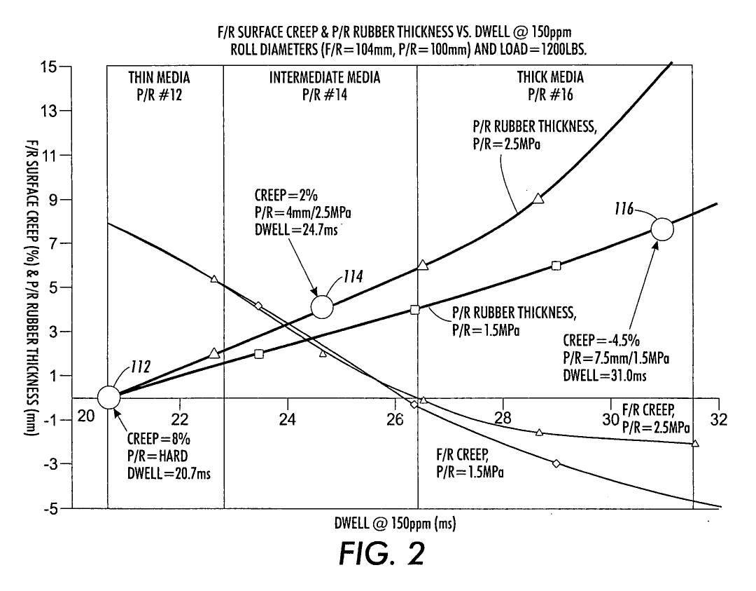

Referring now to FIG. 2 wherein a graph is shown displaying fuser roll surface creep and pressure roll rubber thickness versus dwell time at 150 pages per minute (ppm) using representative configurations of the embodiments of pressure rolls described above. In particular, a fuser roll of 104 mm, a pressure roll of 100 mm, and a load of 1200 lbs were used to determine the following parameters. Specifically, a pressure roll 112 can produce a creep of 8% with a dwell time of 20.7 milliseconds. A pressure roll 114, comprising a silicone layer 4 mm thick, can produce a creep of 2% with a dwell time of 24.7 milliseconds. A pressure roll 116, comprising a silicone layer 7.5 mm thick, can produce a creep of −4.5% with a dwell time of 31.0 milliseconds. Creep can be defined as the percent strain difference on the surface of the fuser roll between ‘in’ the nip and ‘outside’ the nip.

The fuser system of a xerographic device of the present disclosure thus includes a nip width adjustment device in communication with the processor, which can adjust the current nip width by changing the ‘active’ pressure roll associated with the fuser roll. For example, the nip width adjustment device may be associated with the mounting structure of the pressure roll within the xerographic device.

It is to be appreciated that by only using the relatively hard pressure roll, i.e. pressure roll 12, when necessary extends the edge wear life of the fuser roll. This is due to the fact that the extent of mechanical wear of the outside surface of the fuser roll by the media is greatest when using a thin, hard pressure roll in association with the fuser roll. Similarly, using the thickest pressure roll possible maximizes edge wear life and minimizes fuser roll temperature. The disclosure thus enables the fuser latitude to be increased, fuser life to be lengthened, and maintenance upon the fuser system to be reduced as a result of the selective loading of the optimal pressure roll. The nip width is adjusted to maximize fusing performance over the life of the fuser roll.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A fuser system of a xerographic device, comprising:
a fuser roll;
a first pressure roll, a second pressure roll, and a third pressure roll supported for selective pressure engagement against said fuser roll;
a repositioner cooperating with said first, said second, and said third pressure rolls for operatively selectively engaging one of said pressure rolls directly against said fuser roll;
said first pressure roll includes an outer surface having an effective modulus creating a first nip pressure and a first nip width between said first pressure roll and said fuser roll;
said second pressure roll includes an outer surface having an effective modulus creating a second nip pressure and a second nip width between said second pressure roll and said fuser roll;
said first nip pressure and said first nip width is different from said second nip pressure and said second nip width;
said third pressure roll including an outer surface having an effective modulus creating a third nip pressure and a third nip width between said third nip pressure and said fuser roll; and,
said third nip pressure and said third nip width is different from said first and said second nip pressures and nip widths.

2-3. (canceled)

4. A fuser system of a xerographic device, comprising:
a fuser roll;
a first pressure roll, a second pressure roll, and a third pressure roll supported for selective pressure engagement with said fuser roll;
a repositioner cooperating with said first, said second, and said third pressure rolls for operatively selectively engaging one of said pressure rolls directly against said fuser roll;
said first pressure roll includes an outer surface having an effective modulus creating a first nip pressure:
said second pressure roll includes an outer surface having an effective modulus creating a second nip pressure:
said first nip pressure is different from said second nip pressure;
said repositioner moves from a first position to a second
position, said first position resulting in said first nip pressure between said fuser roll and said first pressure roll and said second position resulting in said second nip pressure between said fuser roll and said second pressure roll; and,
said repositioner moves to at least a third position, said third position resulting in a third nip pressure between said fuser roll and said third pressure roll.

5. (cancel)

6. The device of claim 1 further comprising:
a sensor for detecting weight of media passing through the xerographic device and controlling said repositioner in response thereto.

7. A xerographic method including:
operating a heat and pressure fuser including a heated fuser roll, and a plurality of pressure rolls each selectively supported for pressure loading against said fuser roll;
selectively moving a first one of said plurality of pressure rolls to a loaded position directly against said fuser roll in response to a sensor detecting a first weight of media passing through the xerographic device;
moving at least a third one of said plurality of pressure rolls to a loaded position directly against said fuser roll in response to said sensor detecting a third weight of media passing through the xerographic device; and,
each one of said plurality of pressure rolls selectively supported for pressure loading directly against said fuser roll.

8. The method of claim 7 further including:
moving said first one of said plurality of pressure rolls to an unloaded position and moving at least a second one of said plurality of pressure rolls to a loaded position with said fuser roll in response to said sensor detecting a second weight of media passing through the xerographic device.

9. The method of claim 8 wherein said first one of said pressure rolls includes an outer surface having an effective modulus creating a first nip pressure, and said at least second one of said plurality of pressure rolls includes an outer surface having an effective modulus creating a second nip pressure.

10. (cancel)

11. The method of claim 8 wherein said first pressure roll includes an outer layer over an aluminum inner layer and said at least second pressure roll includes an outer layer over a silicone inner layer.

12. The method of claim 11 wherein said silicone layer is from about 4 mm to about 5 mm thick.

13. The method of claim 7 wherein said first pressure roll includes an outer layer over an aluminum inner layer and said at least third pressure roll includes an outer layer over a silicone inner layer.

14. The method of claim 13 wherein said silicone layer is from about 7 mm to about 9 mm thick.

15. A fuser system of a xerographic device, comprising:
a fuser roll;
at least a first and a second pressure roll supported by a repositioner;
said repositioner cooperating with said at least first and second pressure rolls for operatively selectively loading one of said at least first and said second pressure rolls with said fuser roll;
at least a third pressure roll, said at least third pressure roll
loaded directly against said fuser roll includes a third nip pressure having a third dwell time; and,
a sensor for detecting weight of media passing through the
xerographic device and controlling said repositioner in response thereto.

16. The system of claim 15 wherein said at least first pressure roll loaded against said fuser roll includes a first nip pressure having a first dwell time.

17. The system of claim 15 wherein said at least second pressure roll loaded against said fuser roll includes a second nip pressure having a second dwell time.

18. The system of claim 15 wherein said repositioner comprises a central axis, said at least first and second pressure rolls selectively moved about said axis.

19. (cancel)

20. (cancel)

21. The system of claim 15 wherein said repositioner rotates from a first radial position to a second radial position, said first radial position resulting in a first nip pressure between said fuser roll and said first pressure roll and said second radial position resulting in a second nip pressure between said fuser roll and said second pressure roll.

22. The system of claim 15 wherein said repositioner moves in a plurality of positions for forming at least a first and a second nip pressure between said at least first and second pressure rolls and said fuser roll.
